(19) United States
(12) Patent Application Publication
(10) Pub. No.: US 2019/0047577 A1
(43) Pub. Date: Feb. 14, 2019

(54) SYSTEM AND METHOD FOR AUTOMATED VEHICLE BREAKDOWN RECOVERY

(71) Applicant: Walmart Apollo, LLC, Bentonville, AR (US)

(72) Inventors: Nicholas R. Antel, Springdale, AR (US); John J. O'Brien, Farmington, AR (US); Donald R. High, Noel, MO (US); Robert L. Cantrell, Herndon, VA (US)

(21) Appl. No.: 16/033,865

(22) Filed: Jul. 12, 2018

Related U.S. Application Data
(60) Provisional application No. 62/542,874, filed on Aug. 9, 2017.

(51) Int. Cl. B60W 50/00; G05D 1/00; G07C 5/08

(52) U.S. Cl. CPC B60W 50/0098; G07C 5/0808; G05D 1/0088

(57) ABSTRACT

Input signals and a failure indication are received from an automated ground vehicle (AGV) or aerial drone. A type of failure at the AGV or aerial drone is determined based upon analyzing the failure indication and the input signals. When the type of failure is a power failure, a first control signal is transmitted that connects a back-up power source to an electrical power network of the AGV or aerial drone. Upon reception of the failure indication, a second control signal is transmitted to the AGV or aerial drone that instigates a security protection measure at the AGV or aerial drone. A third control signal that is effective to actuate a recovery assistance apparatus is transmitted. The recovery assistance apparatus, upon being actuated, replaces or repairs the failed or suspect component.

### CROSS-REFERENCE TO RELATED APPLICATION

This application claims the benefit of the following U.S. Provisional Application No. 62/542,874 filed Aug. 9, 2017, which is incorporated herein by reference in its entirety.

### TECHNICAL FIELD

These teachings relate generally to automated ground vehicles and, more specifically, to repairing these vehicles when the vehicle breaks down, or preventing the vehicle from breaking down.

### BACKGROUND

Various types of automated ground vehicles (AGVs) are used to perform various functions and tasks. For example, some AGVs deliver products from one location to another location (e.g., within a warehouse, or from a warehouse to the home of a customer). Other AGVs perform monitoring or surveillance functions. Aerial drones can also perform some of these functions.

Whatever their function, AGVs and aerial drones often times are constructed of or contain expensive components. For instance, electronic circuits are often present on AGVs, where the electronic circuit operates the AGVs. For cargo-carrying AGVs, the cargo (e.g., packages) may be expensive. These valuable components and cargo make AGVs an attractive target for thieves, who may attempt to steal the above-mentioned components.

Additionally, other unscrupulous individuals may target AGVs for other nefarious reasons. For instance, some individuals may seek to vandalize AGVs for pleasure.

AGVs and drones sometimes have breakdowns or otherwise become inoperative. Often times, these breakdowns occur far from a repair facility. During the time that the AGV or drone cannot operate, the AGV or drone is susceptible to the different types of criminal or unscrupulous activity described above. Weather or environmental conditions can also be problematic for AGVs or drones when the AGVs or drones break down. For instance, severe or adverse weather or environmental conditions can damage the AGV or drone (or its components and cargo) if the AGV or drone is exposed to these conditions.

### BRIEF DESCRIPTION OF THE DRAWINGS

The above needs are at least partially met through the provision of AGVs or drones with breakdown recovery systems, particularly when studied in conjunction with the drawings, wherein:

FIG. 1 comprises a diagram of a system as configured in accordance with various embodiments of these teachings;

FIG. 2 comprises a flowchart as configured in accordance with various embodiments of these teachings;

FIG. 3 comprises a diagram of a system as configured in accordance with various embodiments of these teachings;

FIG. 4 comprises a diagram of a system as configured in accordance with various embodiments of these teachings;

FIG. 5 comprises a diagram of a system as configured in accordance with various embodiments of these teachings.

### DETAILED DESCRIPTION

Generally speaking, systems and methods are provided that ensure automated ground vehicles (AGVs) (or aerial drones) can recover from breakdowns. In other aspects, various approaches are provided that prevent the AGV (or aerial drone) from becoming inoperative. In some examples, the recovery system may be a box or box-like structure that is incorporated into or with the AGV (or aerial drone). Upon detection of an AGV (or aerial drone) failure, the AGV system assists the AGV (or aerial drone) in recovering from the failure. Additionally, the system secures the AGV (or aerial drone) or portions of the AGV (or aerial drone) from unauthorized intruders.

In many of these embodiments, a retail product delivery automated ground vehicle (AGV) or aerial drone breakdown recovery system is provided. The system includes an interface, a back-up power source, a recovery assistance apparatus, and a control circuit.

The interface is configured to receive input signals and a failure indication from an automated ground vehicle (AGV) or aerial drone. The recovery assistance apparatus is configured to repair or replace a failed or suspect component of the AGV or aerial drone.

The control circuit is coupled to the interface, the back-up power source, and the recovery apparatus. The control circuit is configured to receive the input signals and the failure indication from the interface.

The control circuit is further configured to determine a type of failure at the AGV or aerial drone based upon analyzing the failure indication and the input signals. When the type of failure is a power failure, the control circuit is configured to transmit a first control signal that connects the back-up power source to an electrical power network of the AGV or aerial drone. The control circuit is still further configured to, upon reception of the failure indication, transmit a second control signal to the AGV or aerial drone that instigates a security protection measure at the AGV or aerial drone, and the security protection measure is effective to prevent access to at least some portions of the AGV or aerial drone by an unauthorized user. The control circuit is additionally configured to transmit a third control signal that is effective to actuate the recovery assistance apparatus. The recovery assistance apparatus, upon being actuated, replaces or repairs failed or suspect component.

In aspects, the failure indication includes information identifying a presently occurring breakdown condition or a potential future AGV or aerial drone breakdown condition. Other examples are possible.

In examples, the interface, back-up power source, recovery apparatus, and control circuit are disposed within a single housing. In aspects, the housing is constructed of materials and structured to prevent physical intrusions into the housing or damage to the contents of the housing. In other examples, the interface, back-up power source, recovery apparatus, and control circuit are disposed within a first housing. In other aspects, the system also includes a second housing comprising a second interface, a second back-up power sources, a second recovery apparatus, and a second control circuit.

In still other examples, at least one of the interface, back-up power source, recovery apparatus, or control circuit are disposed within a housing, and others of the interface, back-up power source, recovery apparatus, and control circuit are disposed outside the housing.

In yet other aspects, the system further includes a shield that shields the interface, back-up power source, recovery apparatus, and/or control circuit from radio jams and pulsing. In examples, the shield comprises a coating or lining.

In other examples, the recovery assistance apparatus comprises microdrones or robotic arms that may be able to diagnose or fix the AGV or aerial drone problem. Other examples are possible. In some examples, at least one of the microdrones includes or is attached to a crash survivable recording device (e.g., a “black box”) that is configured to received sensed readings from sensors at the AGV or aerial drone.

In examples, the back-up power source may be a battery, regenerative power supply, tesla coil, solar panel, or DIY Oxyhydrogen generator. Other examples of back-up power sources are possible.

In still other examples, the system further includes a beacon that alerts the central computer of its location. Once alerted, other help or aid can be sent to the AGV or aerial drone.

In others of these embodiments, input signals and a failure indication are received from an automated ground vehicle (AGV) or aerial drone. A type of failure at the AGV or aerial drone is determined based upon analyzing the failure indication and the input signals. When the type of failure is a power failure, a first control signal is transmitted that connects a back-up power source to an electrical power network of the AGV or aerial drone. Upon reception of the failure indication, a second control signal is transmitted to the AGV or aerial drone that instigates a security protection measure at the AGV or aerial drone. The security protection measure is effective to prevent access to at least some portions of the AGV aerial drone by an unauthorized user. A third control signal that is effective to actuate a recovery assistance apparatus is also transmitted. The recovery assistance apparatus, upon being actuated, replaces or repairs the failed or suspect component.

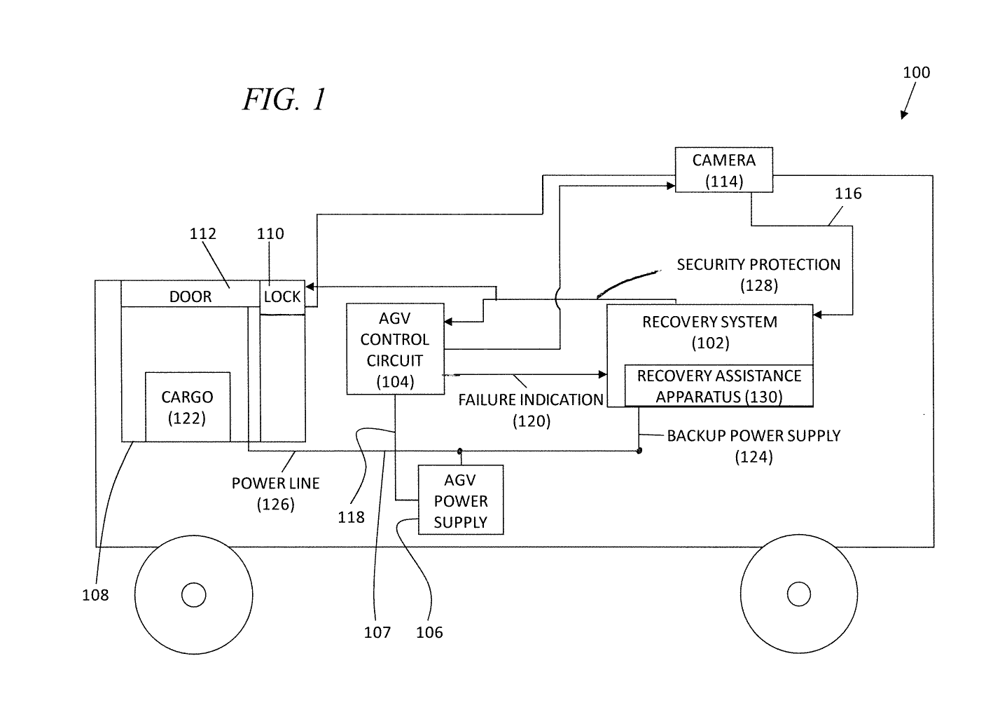

Referring now to FIG. 1, an automated ground vehicle 100 includes a breakdown recovery system 102, an AGV control circuit 104, an AGV power supply 106, a powerline or power bus 107, a cargo area 108 (secured by lock 110 and door 112, and holding a cargo 122), and a camera (or other type of sensing device) 114. The recovery system 102 receives a first input signal 116 from the camera 114, and a failure indication signal 120 from the AGV control circuit 104.

It will be appreciated that the approaches described herein may also be applied to aerial drones. In other words, the automated ground vehicle 100 may be exchanged with an aerial drone 100. The aerial drone would include the breakdown recovery system 102, the control circuit 104, the power supply 106, the powerline or power bus 107, the cargo area 108 (secured by the lock 110 and the door 112, and holding the cargo 122), and the camera (or other type of sensing device) 114. Of course, these elements would be configured, arranged, and dimensioned for inclusion in an aerial drone rather than an automated ground vehicle. Any of the approaches described herein can be deployed in the aerial drone in place of the automated ground vehicle.

In aspects, the breakdown recovery system 102 is a box or box-like structure that is incorporated into or with the AGV 100 (or aerial drone). Various shapes, dimensions, and configurations are possible for the breakdown recovery system 102. Upon detection of an AGV failure, the AGV breakdown recover system 102 assists the AGV 100 (or aerial drone) in recovering from the failure.

Additionally, the system 102 secures the AGV 100 or portions of the AGV 100 (or aerial drone) from unauthorized intruders. To accomplish these and other functions, various components are disposed within the breakdown recovery system 102. Examples of these components are described elsewhere herein.

The AGV control circuit 104 controls aspects of the operation of the AGV 100 (or aerial drone). For example, the AGV control circuit 104 may instruct other equipment or components of the AGV 100 (or aerial drone) to operate (e.g., instruct a camera 114 to obtain images), or may receive sensed parameters (e.g., the speed of the AGV 100) from sensors. The AGV control circuit 104 may operate a motor of the AGV 100 and/or may help navigate the AGV 100 to a destination.

The AGV control circuit 104 may sense a failure in the AGV 100 (or aerial drone) using different approaches. For example, different sensors may provide sensed information to the AGV control circuit 104 and the AGV control circuit 104 evaluates these sensed readings to determine whether a failure has occurred. In a specific example, a sensor senses the voltage or current of a power supply, sends this to the AGV control circuit 104, the AGV control circuit 104 compares this to a predetermined threshold, and when the sensed reading is below a predetermined threshold, a power failure is determined to exist. Other sensors may include temperature, pressure, altitude, speed, movement, motion, or direction sensors. The output of these sensors may couple to a crash survivable “black box” recording device, which, as described elsewhere herein records this information so that, in the event of a catastrophic failure of the AGV 100 or aerial drone, the information is preserved so that a determination can be made, for example, as to the cause of the failure.

The AGV power supply 106 is any type of power supply device such as a battery. Powerline or power bus 107 is an electrical circuit (e.g., wired connection) that supplies power to AGV components.

The door 112 is any type of barrier that opens when the lock 110 is unlocked to allow a cargo 122 to be placed into the cargo area 108 or removed from the cargo area 108. The cargo 122 may be any type of cargo such as packages that include consumer goods.

In some aspects, the camera 114 is used by recovery box 102 to detect intruders. The camera 114 may be a camera or any other type of sensor that obtains any type of images or any combination of types of images. For example, visible or infrared images may be obtained.

The breakdown recovery system 102 receives a first input signal 116 from the camera 114. The first input signal 116 may be or include images from the camera 114. The breakdown recovery system 102 receives a failure indication signal 120 from the AGV control circuit 104. This indicates that something (or the entire) AGV 100 has failed.

The AGV control circuit 104 receives a second input signal 118 from the AGV power supply 106. The second input signal 118 indicates that the power supply 106 has failed. In other aspects, the signal 118 is a voltage or current measurement and the AGV control circuit 104 determines that the AGV power supply 106 has failed (e.g., comparing the measured voltage or current to a predetermined threshold).

The type of failure at the AGV 100 (or aerial drone) may be included in the failure indication signal 120, or may be determined by an analysis made by the breakdown recovery system 102. When the type of failure is a power failure, a back-up power source to an electrical power network of the AGV is used via a back-up power supply line 124, which is coupled to a power bus 126 of the AGV 100 (or aerial drone). Upon reception of the failure indication, a security protection control signal 128 is transmitted from the breakdown recover system 102 to elements of the AGV 100 (or aerial drone) in order to instigate one or more security protection measures at the AGV 100 (or aerial drone). The security protection control signal 128 is effective to prevent access to at least some portions of the AGV 100 (or aerial drone) by an unauthorized user. For example, the security protection control signal 128 may cause the actuation of the lock 110 or cause the AGV control circuit 104 to take additional security precautions.

Another control signal (not shown in FIG. 1) is transmitted to a recovery assistance apparatus 130 and is effective to actuate a recovery assistance apparatus 130. The recovery assistance apparatus 130, upon being actuated, replaces or repairs the failed or suspect component. For example, the recovery assistance apparatus 130 may include microdrones or a robotic arm that is able to replace a defective component. In one specific example, the microdrone or robotic arm may secure a replacement power supply and exchange the replacement power supply with a defective AGV power supply 106. In another example, the microdrones may include cameras that can, in examples, survey any damage to the AGV 100 (or aerial drone 100). In still another example, the robotic arm may include a camera that can be used to survey damage.

Microdrones, in aspects, are sized and/or structured so as to be carried by the AGV 100 or another larger aerial drone. Microdrones, in examples, may have more limited functions and/or capabilities than larger aerial drones or the AGV 100. For example, the microdrones may not carry large packages (or any packages) for commercial delivery. However, as mentioned, at least one of the microdrones may be attached to a “black box” recording device.

The microdrones may be have the same or different configuration, functionality, size, and/or abilities. In one example, some microdrones may carry a camera to survey damage and transit images back to the AGV 100 (or aerial drone). Others of the microdrones may assist in making repairs (e.g., be able to move or exchange components of the AGV 100).

As mentioned, the AGV 100 (or aerial drone) may also include a black box or recording device that records information concerning the operation of the AGV 100 (or aerial drone). The information recorded may include speed, direction, altitude, pressure, movement, or temperature information that is useful in determining causes of failure when the AGV 100 (or aerial drone) experiences a catastrophic failure. The black box or recording device is configured of suitable materials and construction so as to be survivable in the case of the crash and/or complete or nearly complete destruction of the AGV 100 (or aerial drone). In these regards, the black box may be constructed of suitable materials that protect the contents from high pressures, forces, or temperatures. One of the microdrones may attach to this device (or become attached to this device) when a catastrophic failure is detected (e.g., complete failure of all power supplies or an on-board fire). Alternatively, the box may be permanently connected to a dedicated microdrone. In either case, one of the microdrones may be configured to leave the AGV 100 (or aerial drone) so as to preserve the black box upon detection of a catastrophic failure (e.g., a temperature sensor detects a fire).

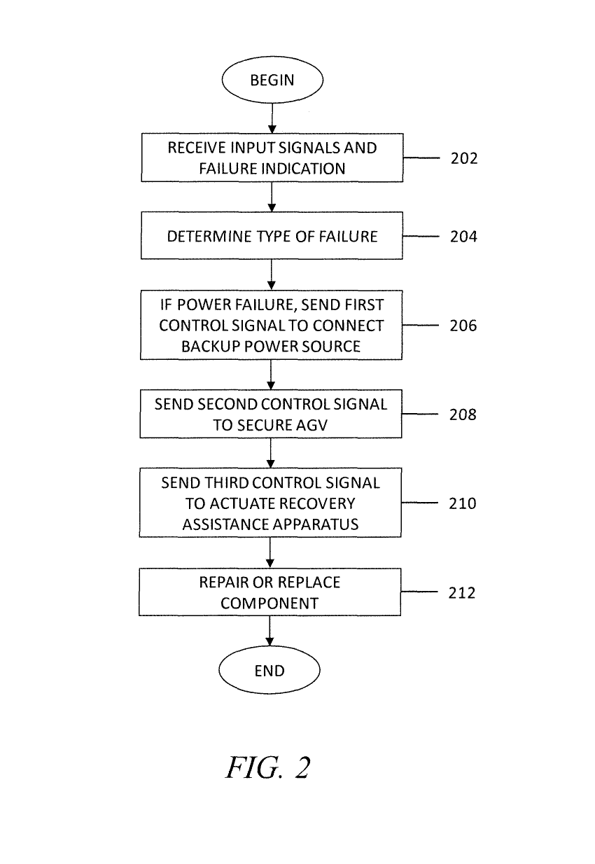

Referring now to FIG. 2, one example of an approach for ensuring the recovery of an AGV is described. As mentioned, these approaches may also be applied to aerial drones. At step 202, input signals and a failure indication are received from an automated ground vehicle (AGV).

At step 204, a type of failure at the AGV is determined based upon analyzing the failure indication and the input signals. The failure indication may indicate a type of failure (e.g., the power supply of the AGV has failed) or the input signals themselves may be analyzed to determine a cause for failure (e.g., input signals directly from the AGV power supply may indicate a low level of power at the AGV power supply).

At step 206, when the type of failure is a power failure, a first control signal is transmitted that connects a back-up power source to an electrical power network of the AGV. The control signal may connect a back-up power source to a power bus in the AGV so that the components in the AGV have electrical power.

At step 208, upon reception of the failure indication, a second control signal is transmitted to the AGV that instigates a security protection measure at the AGV. The security protection measure is effective to prevent access to at least some portions of the AGV by an unauthorized user. In examples, the second control signal may lock a cargo area in the AGV to prevent unauthorized access to the cargo area.

At step 210, a third control signal that is effective to actuate a recovery assistance apparatus is transmitted. The recovery assistance apparatus, in examples, may include a robotic arm and/or mini-drones. These components may, in some aspects, locate a faulty component that is the source of the AGV failure and replace the faulty component.

At step 212, the recovery assistance apparatus, upon being actuated, replaces or repairs the failed or suspect component. For instance, a mini-drone may fly to a faulty component and may replace the component.

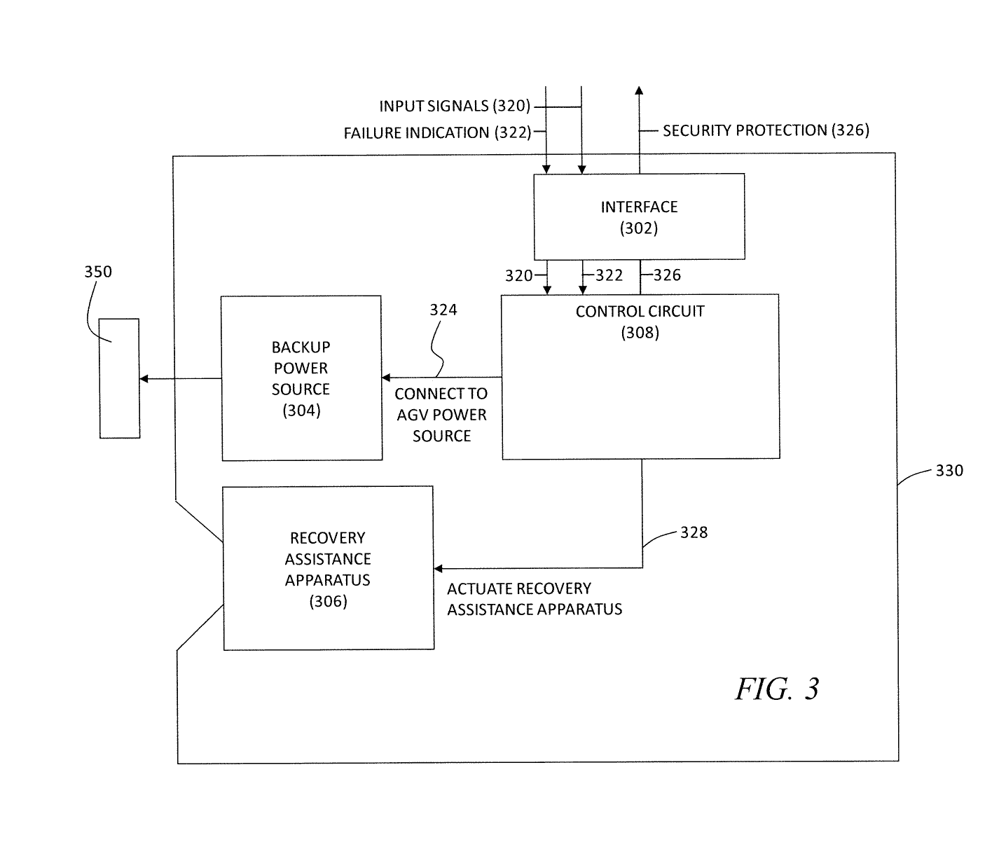

Referring now to FIG. 3, one example of the physical functions of a recovery system 300 is described. The system 300 includes an interface 302, a back-up power source 304, a recovery assistance apparatus 306, and a control circuit 308. The system is deployed on an automated ground vehicle (AGV) or an aerial drone.

The interface 302 is configured to receive input signals 320 and a failure indication 322 from the AGV. The interface 302 is any combination of electronic hardware and software that is able to receive or transmit signals, and convert these signals between appropriate formats.

In aspects, the failure indication 322 includes information identifying a presently occurring breakdown condition or a potential future AGV breakdown condition. Other examples are possible.

In examples, the back-up power source 304 comprise one or more power supplies selected from the group consisting of: batteries, regenerative power supplies, tesla coils, solar panels, DIY Oxyhydrogen generators. Other examples are possible.

The recovery assistance apparatus 306 is configured to repair or replace a failed or suspect component of the AGV. In one example, the recovery assistance apparatus 306 is one or more microdrones. The microdrones can be released by the system 300, and, in some aspects, diagnosis problems, and replace parts. In another example, the recovery assistance apparatus 306 is a robotic arm that is controlled by the control circuit 308. The robotic arm can move, bend, retrieve disabled components from the AGV, and/or replace the disabled components with new, operative components.

The control circuit 308 is coupled to the interface 302, the back-up power source 304, and the recovery assistance apparatus 306. The control circuit 308 is configured to receive the input signals 320 and the failure indication 322 from the interface 302.

It will be appreciated that as used herein the term “control circuit” refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 308 may be configured (for example, by using corresponding programming stored in a memory as will be well understood by those skilled in the art) to carry out one or more of the steps, actions, and/or functions described herein.

The control circuit 308 is configured to determine a type of failure at the AGV based upon analyzing the failure indication 322 and the input signals 320. When the type of failure is a power failure, the control circuit 308 is configured to transmit a first control signal 324 that connects the back-up power source 304 to an electrical power network 350 of the AGV.

The control circuit 308 is further configured to, upon reception of the failure indication 322, transmit a second control signal 326 to the AGV that instigates a security protection measure at the AGV, and the security protection measure is effective to prevent access to at least some portions of the AGV by an unauthorized user.

The control circuit 308 is configured to transmit a third control signal 328 that is effective to actuate the recovery assistance apparatus 306. The recovery assistance apparatus 306, upon being actuated, replaces or the repairs the failed or suspect component.

In examples, the interface 302, back-up power source 304, recovery assistance apparatus 306, and control circuit 308 are disposed within a single housing 330. In aspects, the housing 330 is constructed of materials and structured to prevent physical intrusions into the housing or damage to the contents of the housing 330.

In other examples, the interface 302, back-up power source 304, recovery assistance apparatus 306, and control circuit 308 are disposed within a first housing. The system 300 also includes a second housing including a second interface, a second back-up power sources, a second recovery apparatus, and a second control circuit.

In still other examples, at least one of the interface 302, back-up power source 304, recovery assistance apparatus 306, and control circuit 308 are disposed within the housing 330. Others of the interface 302, back-up power source 304, recovery assistance apparatus 306, and control circuit 308 are disposed outside the housing 330.

In yet other aspects, the system 300 further includes a shield that shields or protects the interface 302, back-up power source 304, recovery assistance apparatus 306, and control circuit 308 from radio jams and pulsing. In examples, the shield comprises a coating or lining that coats or lines the interior, exterior, or both the interior and exterior of the housing 330.

In still other examples, the system further includes a beacon that transmits a beacon signal alerting the central computer of its location. The beacon signal may be generated by the control circuit 308 and may be transmitted from the interface 302 by command of the control circuit 308.

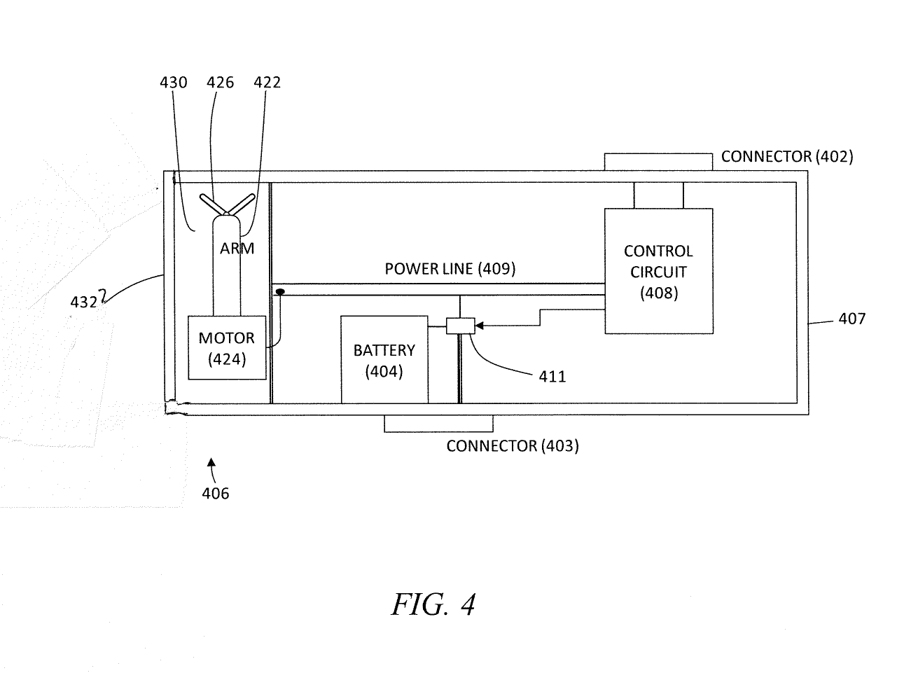

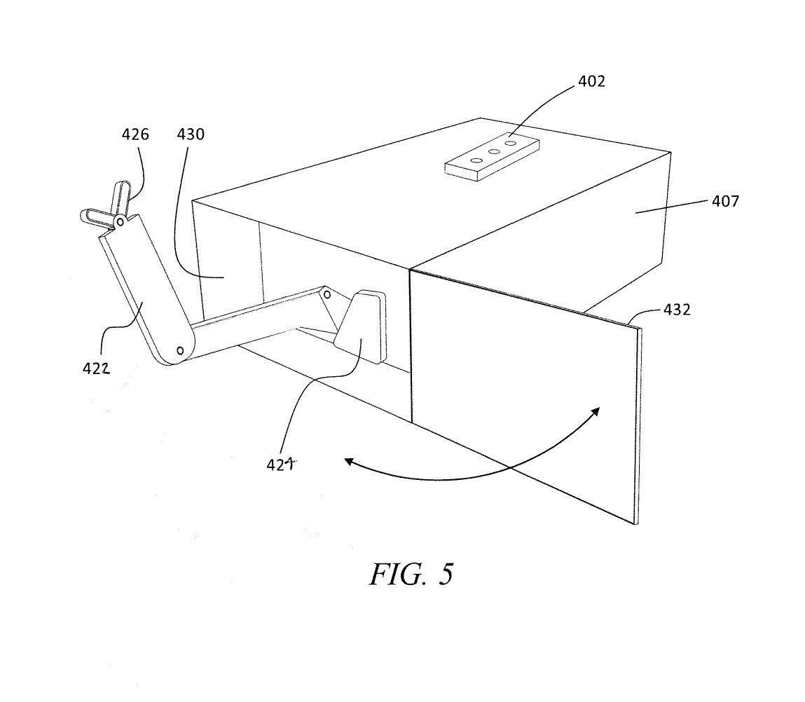

Referring now to FIG. 4 and FIG. 5, one example of a breakdown recovery system 400 is described. The system 400 includes a connector 402, a battery (back-up power source) 404, a recovery assistance apparatus 406, and a control circuit 408. The system is deployed on an automated ground vehicle (AGV) or an aerial drone.

The system is protected by a housing 407. The housing 407 may be constructed of any type of suitable material that can protect the interior components. For example, the housing 407 may be constructed of a metal such as aluminum or steel. Other examples are possible.

The connector 402 allows a connection between elements exterior to the system 100 (e.g., AGV components) and components interior to the housing 407. The battery (back-up power source) 404 may be any type of back-up power source such as a battery.

The recovery assistance apparatus 406 includes a robotic arm structure 422 operated by a motor 424. The arm structure 422 is stored in a compartment 430 that is protected by a door 432 that opens and closes. Once opened, the motor 424 moves the arm to a position where pincers 426 may remove broken components of the AGV. The compartment 430 may store replacement components which can be placed into position by the arm structure 422 and pincers 426. In other examples, microdrones may be deployed in the compartment 430. When the door 432 is opened the microdrones may deploy to remove and replace broken components on the AGV or perform other functions.

The control circuit 408 may operate as the control circuit 308, described above with respect to FIG. 3.

The back-up battery is connected to a power line 409. The power line supplies power to components such as the control circuit 408 and the motor 424.

A switch 411 is actuated by the control circuit 408. In one mode, a determination is made that the system 400 should be activated, but that it does not need to use the back-up battery 404. In this case, the switch 411 is set so that power from the AGV (a power source external to the system 400) supplies power through connector 403 to power line 409 and thus to the components of system 400.

On the other hand, when there is a determination that the AGV needs to use the back-up battery 404, the switch 411 is set so that power from the battery 404 flows to the powerline 409 (to supply components of the system 400) and out through connector 403 to the AGV. It will be appreciated that other configurations are possible. For example, the system 400 may always use the battery 404 for power when the system is activated and may or may not supply power to the AGV through the connector 403 depending upon whether the SGV needs to use the back-up battery 404.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A retail product delivery automated ground vehicle (AGV) or aerial drone breakdown recovery system, the system comprising:
an interface, the interface configured to receive input signals and a failure indication from an automated ground vehicle (AGV) or aerial drone;
a back-up power source;
a recovery assistance apparatus, the recovery assistance apparatus being configured to repair or replace a failed or suspect component of the AGV or aerial drone;
a control circuit coupled to the interface, the back-up power source, and the recovery apparatus, the control circuit configured to:
receive the input signals and the failure indication from the interface;
determine a type of failure at the AGV or aerial drone based upon analyzing the failure indication and the input signals;
when the type of failure is a power failure, transmit a first control signal that connects the back-up power source to an electrical power network of the AGV or aerial drone;
upon reception of the failure indication, transmit a second control signal to the AGV or aerial drone that instigates a security protection measure at the AGV or aerial drone, the security protection measure being effective to prevent access to at least some portions of the AGV or aerial drone by an unauthorized user;
transmit a third control signal that is effective to actuate the recovery assistance apparatus, the recovery assistance apparatus, upon being actuated, replacing or repairing the failed or suspect component.

2. The system of claim 1, wherein the failure indication includes information identifying a presently occurring breakdown condition or a potential future breakdown condition.

3. The system of claim 1, wherein the interface, back-up power source, recovery apparatus, and control circuit are disposed within a single housing.

4. The system of claim 3, wherein the housing is constructed of materials and structured to prevent physical intrusions into the housing or damage to the contents of the housing.

5. The system of claim 1, wherein the interface, back-up power source, recovery apparatus, and control circuit are disposed within a first housing, and wherein the system includes a second housing including a second interface, a second back-up power sources, a second recovery apparatus, and a second control circuit.

6. The system of claim 1, wherein at least one of the interface, back-up power source, recovery apparatus, and control circuit are disposed within a housing and others of the interface, back-up power source, recovery apparatus, and control circuit are disposed outside the housing.

7. The system of claim 1, further comprises a shield that shields the interface, back-up power source, recovery apparatus, and control circuit from radio jams and pulsing.

8. The system of claim 7, wherein the shield comprises a coating or lining.

9. The system of claim 1, wherein the recovery assistance apparatus comprises one or more of: microdrones or robotic arms that may be able to diagnose or fix a AGV or drone problem.

10. The system of claim 9, wherein at least one of the microdrones includes or is attached to a crash survivable recording device that is configured to receive sensed readings from sensors at the AGV or aerial drone.

11. The system of claim 1, wherein the back-up power source comprises one or more power supplies selected from the group consisting of: batteries, regenerative power supplies, tesla coils, solar panels, or DIY Oxyhydrogen generators.

12. The system of claim 1, further comprising a beacon to alert the central computer of its location.

13. A method of providing recovery from a breakdown for an automated ground vehicle or aerial drone, the method comprising:
receiving input signals and a failure indication from an automated ground vehicle (AGV) or aerial drone;
determining a type of failure at the AGV or aerial drone based upon analyzing the failure indication and the input signals;
when the type of failure is a power failure, transmitting a first control signal that connects a back-up power source to an electrical power network of the AGV or aerial drone;
upon reception of the failure indication, transmitting a second control signal to the AGV or aerial drone that instigates a security protection measure at the AGV or aerial drone, the security protection measure being effective to prevent access to at least some portions of the AGV or aerial drone by an unauthorized user;
transmitting a third control signal that is effective to actuate a recovery assistance apparatus, the recovery assistance apparatus, upon being actuated, replacing or repairing the failed or suspect component.

14. The method of claim 13, wherein the failure indication includes information identifying a presently occurring breakdown condition or a potential future AGV breakdown condition.

15. The method of claim 13, wherein the steps are performed at control circuit are disposed within a housing.

16. The method of claim 15, wherein the housing is constructed of materials and structured to prevent physical intrusions into the housing or damage to the contents of the housing.

17. The method of claim 15, further comprising disposing a shield at the housing.

18. The method of claim 17, wherein the shield comprises a coating or lining.

19. The method of claim 13, wherein the recovery assistance apparatus comprises one or more of: microdrones or robotic arms that may be able to diagnose or fix AGV problem.

20. The method of claim 19, wherein at least one of the microdrones includes or is attached to a crash survivable recording device that is configured to received sensed readings from sensors at the AGV or aerial drone.

21. The method of claim 13, wherein the back-up power source comprises one or more power supplies selected from the group consisting of: batteries, regenerative power supplies, tesla coils, solar panels, or DIY Oxyhydrogen generators.

22. The method of claim 13, further comprising using a beacon to alert the central computer.
